(19) United States
(12) Patent Application Publication
(10) Pub. No.: US 2008/0025552 A1
(43) Pub. Date: Jan. 31, 2008

(54) Magnetic circuit for speaker device and speaker device

(75) Inventors: Hiroyuki Dohi, Yamagata (JP); Kunio Mitobe, Yamagata (JP)

Correspondence Address: NIXON & VANDERHYE, PC, 901 NORTH GLEBE ROAD, 11TH FLOOR, ARLINGTON, VA, 22203, US

(73) Assignees: Pioneer Corporation, Tokyo (JP); Tohoku Pioneer Corporation, Tendo-shi (JP)

(21) Appl. No.: 11/878,788

(22) Filed: Jul. 26, 2007

(30) Foreign Application Priority Data
Jul. 26, 2006 (JP) 2006-203590

(51) Int. Cl. H04R 1/00

(52) U.S. Cl. 381/421

(57) ABSTRACT

A magnetic circuit for a speaker device includes: a yoke which has magnetism and has a center pole formed into a column shape; and plural flat plate-shaped magnets which are uniformly arranged around the center pole and form a magnetic gap with the center pole. Each of the magnets is magnetized in a direction in parallel with a thickness direction and in a direction of the center pole. The magnetic circuit for the speaker device is a radial-type magnetic circuit. Since each of the flat plate-shaped magnets is formed not into a circular arc shape but into a flat plate shape, it becomes easy to form the magnets, and the number of procedures of forming of the magnets can be reduced. Additionally, since each of the flat plate-shaped magnets is magnetized in the thickness direction, a special magnetization machine becomes unnecessary. Thus, the number of procedures of magnetizing of the flat plate-shaped magnets can be reduced. As a result, the manufacturing cost of the magnetic circuit can be reduced.

### BACKGROUND OF THE INVENTION

1. Field of the Invention

The present invention relates to a configuration of a magnetic circuit for a speaker device.

2. Description of Related Art

Conventionally, there is known a radial-type magnetic circuit for a speaker device, having a yoke and an annular magnet magnetized in a radial direction, and capable of obtaining high magnetic efficiency by forming a magnetic gap between the yoke and the magnet.

An example of the magnetic circuit of this kind is disclosed in Japanese Patent Application Laid-open under No. 2002-27591 (Reference-1). In the magnetic circuit according to Reference-1, the circular arc-shaped magnet forms the magnetic gap with the center pole or the yoke, and cut-out parts are provided at plural positions of the yoke or the center pole opposite to the magnet via the gap, where the magnetic density of the magnet is sparse. Thereby, the heat radiation effect of the magnetic circuit can be obtained.

However, the above-mentioned radial-type magnetic circuit has such a problem that a special magnetization machine for magnetizing the annular magnet in the radial direction (magnet diameter direction) becomes necessary and the number of procedures is increased by the amount.

In addition to the above problem, the magnetic circuit according to Reference-1 also has such a problem that, since the magnet has to be formed into the circular arc shape, the working is more difficult as compared with forming the annular magnet, and thus the number of procedures is further increased by the amount.

Hence, the above radial-type magnetic circuit and the magnetic circuit according to Reference-1 have such a problem that the manufacturing cost of the magnetic circuit is increased in accordance with increasing of the number of procedures.

### SUMMARY OF THE INVENTION

The present invention has been achieved in order to solve the above problems. It is an object of this invention to provide a radial-type magnetic circuit for a speaker device and a speaker device including the magnetic circuit, mainly capable of reducing a manufacturing cost.

According to one aspect of the present invention, there is provided a magnetic circuit for a speaker device including: a yoke which has magnetism and has a center pole formed into a column shape; and plural flat plate-shaped magnets which are uniformly arranged around the center pole and form a magnetic gap with the center pole, wherein each of the flat plate-shaped magnets is magnetized in a direction in parallel with a thickness direction and in a direction of the center pole.

The above magnetic circuit for the speaker device includes the yoke having the magnetism and having the center pole formed into the column shape and plural flat plate-shaped magnets, uniformly arranged around the center pole and forming the magnetic gap with the center pole. Each of the flat plate-shaped magnets is magnetized in the direction in parallel with the thickness direction and in the direction of the center pole. The thickness direction of each flat plate-shaped magnet may be substantially orthogonal to a projecting direction of the center pole.

In a preferred example, a first plate having magnetism may be provided between each of the flat plate-shaped magnets and the center pole. In addition, a second plate having magnetism may be provided on an outer side of each of the flat plate-shaped magnets.

Thereby, the magnetic circuit for the speaker device forms the radial-type magnetic circuit including the plural flat plate-shaped magnets. Since each of the magnets is formed not into the above circular arc shape of Reference-1 (comparative example) but into the flat plate shape, it is easier to form the magnet, as compared with the comparative example, and the number of procedures of forming the magnet can be reduced. In addition, since each of the flat plate-shaped magnets is magnetized in the thickness direction, the special magnetization machine is unnecessary at the time of magnetizing of each flat plate-shaped magnet. Therefore, the number of procedures of magnetizing of each flat plate-shaped magnet can be reduced, as compared with the above comparative example. In this manner, since the number of procedures can be reduced, the manufacturing cost of the magnetic circuit can be reduced.

Additionally, since the magnetic circuit for the speaker device forms the radial-type magnetic circuit with using the plural flat plate-shaped magnets, the magnet efficiency is enhanced, as compared with the radial-type magnetic circuit formed with using the circular arc-shaped magnets according to the comparative example. In the comparative example, since the neighboring magnets are attached to each other, at the attachment part, the magnetic flux decreases due to the influence of repulsive magnetic field, and the magnet efficiency also decreases. Meanwhile, in the magnetic circuit for the speaker device in this example, since the plural flat plate-shaped magnets are uniformly arranged around the center pole, the magnetic flux becomes uniform in the entire magnetic gap, and the magnet efficiency is enhanced, as compared with the comparative example. Thus, by the component of the magnetic circuit for the speaker device, the material cost of the magnet can be reduced, and the magnetic circuit can be light, as compared with the comparative example.

In a manner of the above magnetic circuit for the speaker device, it may be prescribed that the neighboring flat plate-shaped magnets are not attached to each other. Therefore, at the time of assembling of the magnetic circuit for the speaker device, since the repulsive magnetic field is never generated at the boundary part between the neighboring flat plate-shaped magnets, each of the magnets can be easily mounted on the magnetic circuit without receiving the influence of the repulsive magnetic field. Hence, the efficiency of assembling of the magnetic circuit for the speaker device can be improved, as compared with the above comparative example.

In this manner, the neighboring flat plate-shaped magnets are not attached to each other, as described above. Thus, in the magnetic gap corresponding to the boundary part of the neighboring flat plate-shaped magnets, since the magnetic flux of the one flat plate-shaped magnet is added to the magnetic flux of the other flat plate-shaped magnet, the magnetic flux becomes dense. Namely, in the magnetic gap corresponding to the area having the largest distance from the flat plate-shaped magnet to the center pole, the magnetic flux becomes dense. Meanwhile, in the magnetic gap corresponding to the area having the smallest distance from the magnet formed into the flat plate shape to the center pole, since only the single flat plate-shaped magnet exists, the magnetic flux becomes sparse, as compared with the above-mentioned area having the dense magnetic flux. Thereby, the magnetic flux can be uniform in the entire magnetic gap formed in the circumferential direction of the center pole.

In another manner of the above magnetic circuit for the speaker device, an outer circumference of the center pole may be formed into a rectangle, and a first plate having an inner circumference formed into a rectangle may be arranged between each of the flat plate-shaped magnets and the center pole.

According to another aspect of the present invention, there is provided a speaker device including the above-mentioned magnetic circuit for the speaker device.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a cross-sectional view of a speaker device 100 including a magnetic circuit according to an embodiment of the present invention;

FIGS. 2A and 2B are a disassembly perspective view and a perspective view of the magnetic circuit according to this embodiment;

FIG. 3 is a front view of the magnetic circuit according to this embodiment;

FIG. 4 is a front view of a magnetic circuit according to a comparative example;

FIG. 5 is a graph showing relations between magnitudes of magnetic fluxes in the magnetic circuit of this embodiment and the magnetic circuit of the comparative example and angles in circumferential directions of the magnetic circuits;

FIGS. 6A and 6B are perspective views of magnetic circuits according to a first modification and a second modification;

FIGS. 7A and 7B are perspective views of magnetic circuits according to a third modification and a fourth modification; and

FIG. 8 is a perspective view of a magnetic circuit according to a fifth modification.

### DETAILED DESCRIPTION OF THE PREFERRED EMBODIMENTS

Now, a preferred embodiment of the present invention will be described below, with reference to the attached drawings.

### [Configuration of Speaker Device]

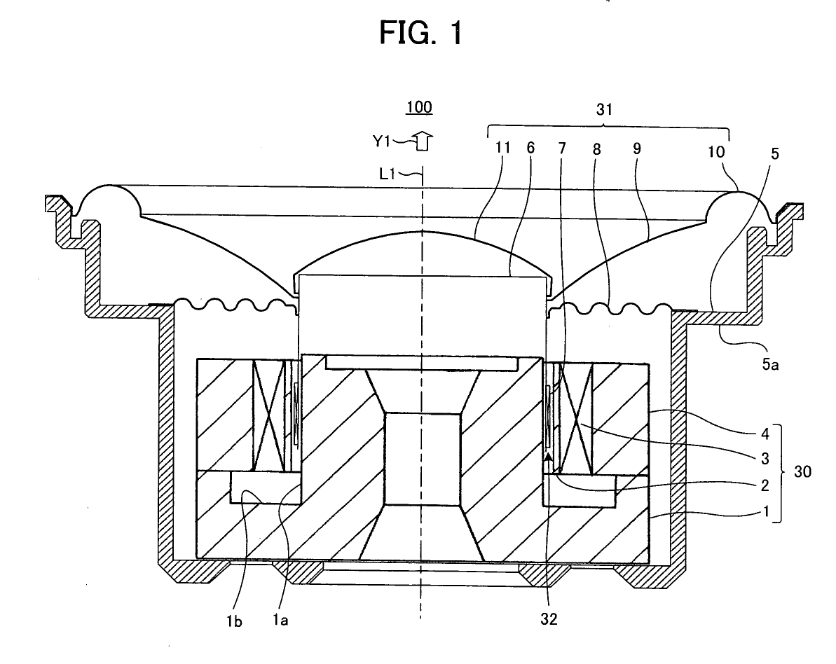

First, a description will be given of a configuration of a speaker device 100 including a speaker device magnetic circuit 30 according to an embodiment of the present invention, with reference to FIG. 1 to FIG. 3.

FIG. 1 shows a cross-sectional view of the speaker device 100 including the speaker device magnetic circuit 30 according to the embodiment of the present invention when cut by a plane passing through a central axis L1.

The speaker device 100 mainly includes: the magnetic circuit 30 including a yoke 1, a first plate 2, plural magnets 3 and plural second plates 4; a frame 5; and a vibration system member 31 including a voice coil bobbin 6, a voice coil 7, a damper 8, a diaphragm 9, an edge 10 and a cap 11.

### (Configuration of Magnetic Circuit)

Now, the configuration of the magnetic circuit 30 will be explained with reference to FIG. 1 to FIG. 3.

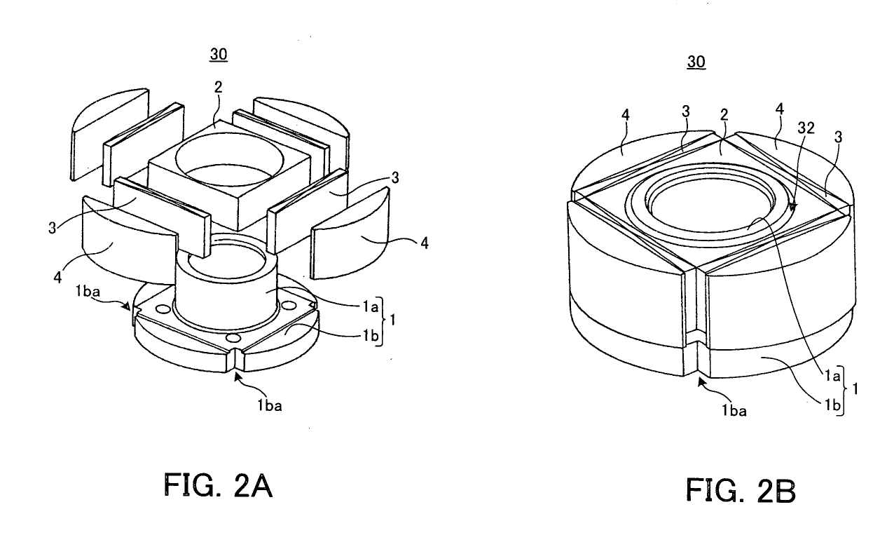

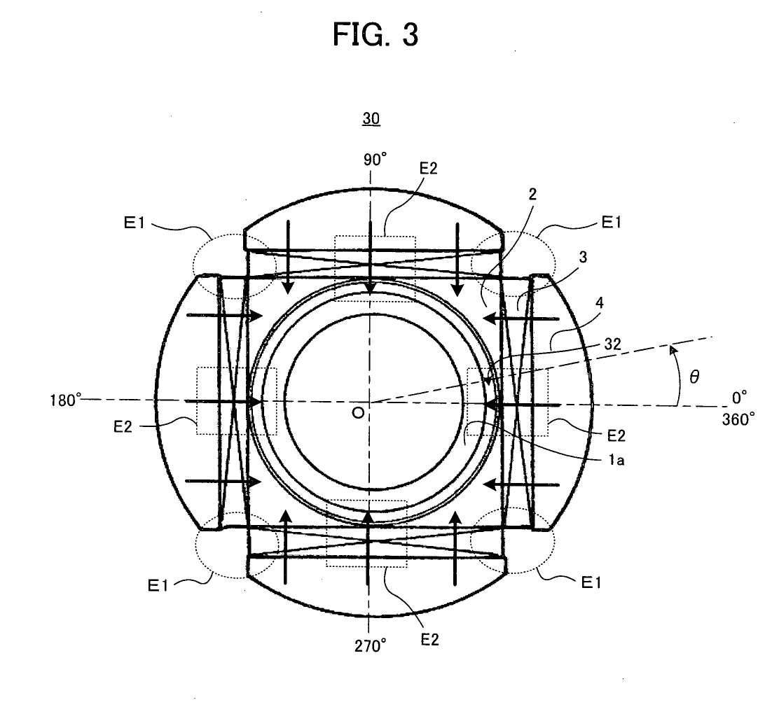

FIG. 2A shows a disassembly perspective view of the magnetic circuit 30. FIG. 2B is a perspective view showing such a state that the magnetic circuit 30 shown in FIG. 2A is assembled. FIG. 3 is a front view of the magnetic circuit 30 when observed from the direction opposite to the direction of an arrow Y1 shown in FIG. 1.

The magnetic circuit shows the so-called radial-type magnetic circuit.

The yoke 1 has the magnetism and has a center pole 1a formed into a column shape (a hollow column shape in this embodiment), and a flange part 1b, formed to outwardly extend from a lower end part of an outer peripheral wall of the center pole 1a. The flange part 1b has cut-out parts 1ba at positions corresponding to the vicinity of the boundary of the neighboring magnets 3 and the vicinity of the boundary of the neighboring second plates 4, respectively.

The first plate 2, having the magnetism, is formed into a rectangular parallelepiped having an opening having a diameter larger than that of the center pole 1a. The first plate 2 is mounted on the flange part 1b so that a constant gap is formed between its inner peripheral wall and the outer peripheral wall of the center pole 1a. This gap is a magnetic gap 32 in which the magnetic flux of each of the magnets 3 is concentrated, which will be described later.

Each of the magnets 3 has a flat plate shape. The magnets 3 are arranged at positions surrounding the center pole 1a, and are divided into four parts in the circumferential direction of the center pole 1a. In such a state, the magnets 3 are mounted on the outer wall of the first plate 2. In addition, the magnets 3 are uniformly arranged around the center pole 1a, and form the magnetic gap 32 with the center pole 1a via the first plate 2. As shown by arrows in FIG. 3, each of the magnets 3 is magnetized in the direction in parallel with its thickness direction and in the direction of the center pole 1a. The thickness direction of each of the magnets 3 is a direction substantially orthogonal to the projecting direction (the arrow Y1 direction shown in FIG. 1) of the center pole 1a. Additionally, as shown in broken-line areas E1 shown in FIG. 3, the neighboring flat plate-shaped magnets 3 are not attached to each other.

Each of the second plates 4, having the magnetism, is formed into a circular arc-shaped, half-circular or semicylindrical cross section. Each of the second plates 4 is mounted on the outer side of each of the magnets 3.

The frame 5 has a bowl shape and a step-shaped cross section, and supports various kinds of components forming the speaker device 100. The frame 5 has a step shape at the middle part, and has a step part 5a on which the outer peripheral part of the damper 8 is mounted. The damper 8 will be explained later. The magnetic circuit 30 is mounted on the lower end part of the frame 5.

### (Configuration of Vibration System Member)

The voice coil bobbin 6 has a cylindrical shape, and is arranged at a position covering the outer peripheral wall of the center pole 1a being the component of the yoke 1.

The voice coil 7 includes a pair of lead wires (not shown) including a plus lead wire and a minus lead wire, and is wound around the vicinity of the lower end part of the outer peripheral wall of the voice coil bobbin 6. Thus, the voice coil 7 is provided in the magnetic gap 32. The plus lead wire is an input wire of an L (or R) channel signal, and the minus lead wire is an input wire of a ground (GND) signal. Each of the lead wires is electrically connected to a speaker device terminal (not shown) provided at an appropriate position of the frame 5. The speaker device terminal is also electrically connected to a pair of output wires including a plus wire and a minus wire of an amplifier. Thereby, one-channel signal and power (hereinafter simply referred to as “sound current”) of the amplifier are inputted to the voice coil 7, respectively.

The damper 8, having an annular shape and plural concentric corrugations, elastically supports the voice coil bobbin 6. An inner peripheral edge part of the damper 8 is mounted on the upper end part of the outer peripheral wall of the voice coil bobbin 6, and the outer peripheral part of the damper 8 is mounted on the step part 5a of the frame 5.

The diaphragm 9, formed into a cone shape, has a function to output an acoustic wave corresponding to the input signal. The inner peripheral edge part of the diaphragm 9 is mounted on the upper end part of the outer peripheral wall of the voice coil bobbin 6.

The edge 10, having an annular shape and an Ω-shaped cross section, has a function to absorb unnecessary vibration generated in the speaker device 100. The inner peripheral edge part of the edge 10 is mounted on the outer peripheral edge part of the diaphragm 9, and the outer peripheral edge part of the edge 10 is mounted on the upper end part of the frame 5.

The cap 11, formed into a dome shape, has a function to prevent dust from entering the inside of the speaker device 100. The cap 11 is arranged at a position covering the upper surface of the voice coil bobbin 6, and is mounted on the sound output surface of the diaphragm 9.

In the speaker device 100 having the above configuration, the sound current outputted from the amplifier is inputted to the voice coil 7 via the speaker device terminal and the pair of lead wires including the plus wire and the minus wire of the voice coil 7. Thereby, in accordance with Fleming's left-hand rule, the driving force is generated to the voice coil 7 in the magnetic gap 32, which vibrates the diaphragm 9 in the direction of the central axis L1 of the speaker device 100. Thereby, the acoustic wave is outputted in the direction of the arrow Y1 via the diaphragm 9.

Next, a description will be given of advantage of the magnetic circuit according to the embodiment of the present invention, which is compared with the comparative example.

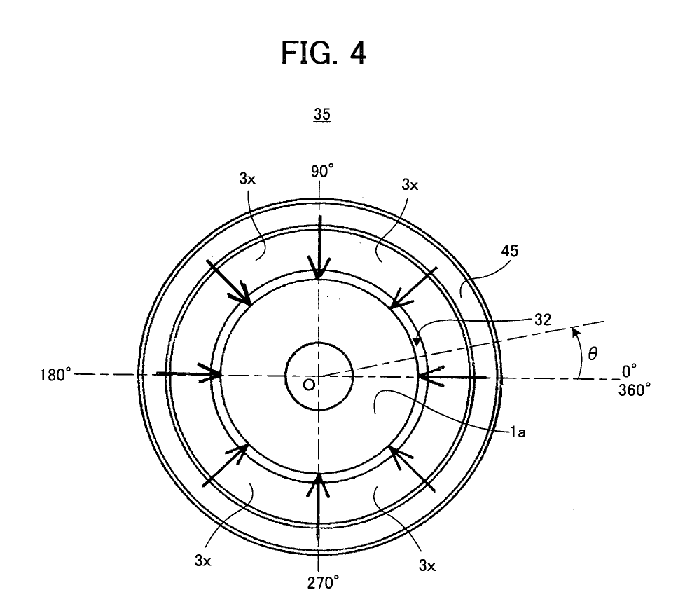

First, a description will be given of a configuration of a magnetic circuit 35 according to the comparative example, with reference to FIG. 4. Hereinafter, the same numeral numbers are given to the same components as those of the above embodiment, and explanations thereof are omitted.

The magnetic circuit 35 according to the comparative example includes the yoke 1 having the center pole 1a and the flange part 1b, plural magnets 3x having the circular arc-shaped, half-circular or semicylindrical cross section, and a plate 45 having an annular shape. The magnetic circuit 35 is the so-called radial-type magnetic circuit.

As shown by arrows in FIG. 4, each of the magnets 3x is magnetized in its thickness direction and in the radial direction of the center pole 1a. The magnets 3x are arranged at the position surrounding the center pole 1a, and are divided into four parts in the circumferential direction of the center pole 1a. The terminal parts of the neighboring magnets 3x are attached to each other, and the magnetic gap 32 is formed between each of the magnets 3x and the center pole 1a. The plate 45, having an annular shape, is arranged at the position covering the each of the magnets 3x.

In the comparative example having the above-mentioned configuration, it is necessary that the magnets are formed into the circular arc shape. There is such a problem that forming of the circular arc-shaped magnets is difficult and the number of procedures is increased by the amount, as compared with forming the annular magnets. Additionally, in the comparative example, there is also such a problem that the special magnetization machine is necessary for magnetizing the magnet 3x formed into the circular arc shape in the radial direction (magnet diameter direction) and thereby the number of procedures for magnetization correspondently is increased. Hence, in the comparative example, the manufacturing cost of the magnetic circuit 35 is problematically increased in correspondence with the increase of the number of procedures.

In the comparative example, as for the pair of neighboring magnets 3x, the positional relation of an S-pole and an N-pole between an end part of the one magnet 3x and an end part of the other magnet 3x attached to the end part is reversed, which is not shown in the drawing. Thus, when the neighboring magnets 3x are attached to each other at the time of assembling of the magnetic circuit 35, both of the neighboring magnets 3x repel each other. The efficiency of the assembly work of the magnetic circuit 35 problematically decreases due to the influence of the repulsive magnetic field.

In the comparative example, since the positional relation of the S-pole and the N-pole between the end parts of the neighboring magnets 3x is reversed as described above, it is problematic that the magnetic fluxes cancel out with each other in the magnetic gap 32 corresponding to the boundary part of the neighboring magnets 3x and thereby the magnetic flux decreases.

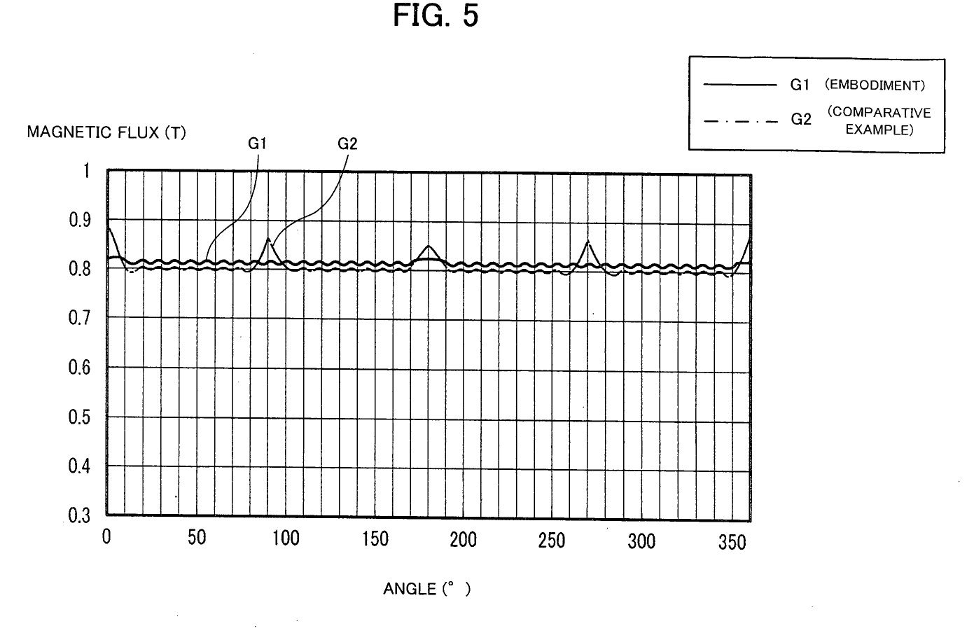

As for this point, an experimental result is shown in a graph in FIG. 5. FIG. 5 is the graph showing a relation between a magnetic flux (T) and an angle (θ) of the magnetic circuit 35 according to the comparative example and the magnetic circuit 30 according to the embodiment. In FIG. 5, the vertical axis indicates the magnitude of the magnetic flux (T), and the horizontal axis indicates the angle (°) in the circumferential direction of the magnetic circuit. Namely, when the position of the magnetic circuit 30 or 35 on the right side of FIG. 3 and FIG. 4 is prescribed as 0° (or 360°), the angle (°) indicates the angle θ measured in the counterclockwise rotation with respect to the position. In FIG. 5, a graph G1 shown by a solid line indicates the graph of the magnetic circuit 30 of this embodiment, and a graph G2 shown by a chain line indicates the graph of the magnetic circuit 35 according to the comparative example.

As shown in the graph in FIG. 5, decreasing of the magnetic flux is seen in the vicinity of four angles 0° (=360°), 90°, 180° and 270° in the comparative example. This is because, in the comparative example, the boundary part at which the positional relation of the S-pole and the N-pole of the end parts of the neighboring magnets 3x is reversed corresponds to the angles 0° (=360°), 90°, 180° and 270°, and the magnetic fluxes cancel out with each other in the magnetic gap 32 corresponding to the boundary part, and thereby the magnetic flux decreases. Thus, in the comparative example, there is such a problem that the magnetic flux cannot be uniformly formed in the circumferential direction of the magnetic gap 32.

It is effective to employ the configuration of the magnetic circuit 30 according to this embodiment, in order to solve the above-mentioned problem.

Namely, the magnetic circuit 30 according to this embodiment includes the yoke 1, having the magnetism and including the center pole 1a formed into the column shape, and the plural flat plate-shaped magnets 3, uniformly arranged around the center pole 1a and forming the magnetic gap 32 with the center pole 1a. Each of the flat plate-shaped magnets 3 is magnetized in the direction in parallel with the thickness direction and in the direction of the center pole 1a, as shown by the arrows in FIG. 3. The thickness direction of each of the flat plate-shaped magnets 3 is substantially orthogonal to the projecting direction of the center pole 1a.

Thereby, the magnetic circuit forms the radial-type magnetic circuit including the plural flat plate-shaped magnets 3. Since each of the magnets 3 is formed not into the circular arc shape shown in the comparative example but into the flat plate shape, the forming of the magnets 3 becomes easy, and thereby the number of procedures of forming of the magnets 3 can be reduced, as compared with the comparative example. In addition, since each of the flat plate-shaped magnets 3 is magnetized in the thickness direction, the special magnetization machine is unnecessary at the time of magnetizing of each of the flat plate-shaped magnets 3. Thus, the number of procedures of magnetizing of the flat plate-shaped magnets 3 can be reduced, as compared with the above comparative example. In this manner, since the number of procedures can be reduced, the manufacturing cost of the magnetic circuit 30 can be reduced.

In the magnetic circuit 30 according to this embodiment, the neighboring flat plate-shaped magnets 3 are not attached to each other, as shown in the broken line areas E1 in FIG. 3. Therefore, since the repulsive magnetic field is never generated at the boundary part of the neighboring flat plate-shaped magnets 3 at the time of assembling of the magnetic circuit 30, each of the magnets 3 can be easily mounted on the outer wall of the first plate 2 without any effects of the repulsive magnetic field. Thus, the efficiency of the assembling of the magnetic circuit 30 can be enhanced, as compared with the comparative example.

As described above, the neighboring flat plate-shaped magnets 3 are not attached to each other. Hence, in the magnetic gap 32 corresponding to the boundary part (broken line area E1) of the neighboring flat plate-shaped magnets 3, since the magnetic flux of the one flat plate-shaped magnet 3 is added to the magnetic flux of the other flat plate-shaped magnet 3, the magnetic flux becomes dense. Namely, in the magnetic gap 32 corresponding to the broken line area E1 having the largest distance from the flat plate-shaped magnet 3 to the center pole 1a, the magnetic flux becomes dense. Meanwhile, in the magnetic gap 32 corresponding to the broken line area E2 having the shortest distance from the flat plate-shaped magnet 3 to the center pole 1a, since only the single flat plate-shaped magnet 3 exists, the magnetic flux becomes sparse, as compared with the magnetic flux generated in the magnetic gap 32 corresponding to the broken line area E1. Thereby, in this embodiment, the magnetic flux can be uniform in the entire magnetic gap 32 formed in the circumferential direction of the center pole 1a, as shown by the graph G1 in FIG. 5.

Additionally, in this embodiment, since the radial-type magnetic circuit is formed by the plural flat plate-shaped magnets 3, the magnet efficiency is enhanced, as compared with the radial-type magnetic circuit formed by the circular arc-shaped magnets 3x shown in the comparative example. The reason will be explained below. In the comparative example, since the neighboring magnets are attached to each other, because of the above reason, the magnetic flux decreases and the magnet efficiency becomes lower at the attached part. Meanwhile, in this embodiment, because of the above reason and the uniform arrangement of the plural flat plate-shaped magnets around the center pole, the magnetic flux becomes uniform in the entire magnetic gap 32, and the magnet efficiency is enhanced, as compared with the comparative example. As for a configuration (i.e., additional comparative example) of a radial-type magnetic circuit formed by an annular magnet, the comparative example and this embodiment, the amount of used magnet necessary for uniforming the magnitude of the magnetic density formed in each of the magnetic gaps is compared under the same condition. As a result, the magnet of 36.2 (g) is necessary in the additional comparative example, and the magnet of 44.7 (g) is necessary in the comparative example. In addition, the magnet of 33.8 (g) is necessary in this embodiment. “The same condition” means that the components other than the magnet are substantially same in each of the magnetic circuits of the additional comparative example, the comparative example and this embodiment.

By the above experimental result, it is understood that, in the case of using the magnetic circuit in which the same performance can be obtained in the additional comparative example, the comparative example and this embodiment, the amount of used magnet can be reduced most in this embodiment, as compared with the additional comparative example and the comparative example. Thus, in this embodiment, the material cost of the magnet can be low and the magnetic circuit 30 can be light, as compared with the additional comparative example and the comparative example.

In this embodiment, the cut-out parts 1ba are provided at the parts of the flange part 1b (i.e., the parts of the flange part 1b corresponding to the broken line area E1) corresponding to the vicinity of the boundary of the neighboring magnets 3 and the vicinity of the boundary of the neighboring second plates 4, which enables what will be described below. Thus, in this embodiment, in consideration of the neighboring magnets 3, the positional relation of the S-pole and the N-pole of the one magnet 3 and the other magnet 3 is reversed. Therefore, at the boundary part (broken line E1) of the neighboring magnets 3, the magnetic flux of the one magnet 3 and the magnetic flux of the other magnet 3 cancel out with each other, and the magnetic flux easily decreases. However, in this embodiment, since the cut-out parts 1ba are provided at the flange part 1b corresponding to the broken line area E1, the short-circuit of the magnetic flux is easily generated at the part of the magnetic circuit 30 corresponding to each of the broken line areas E1, and the decreasing of the magnetic flux can be suppressed.

### [Modification]

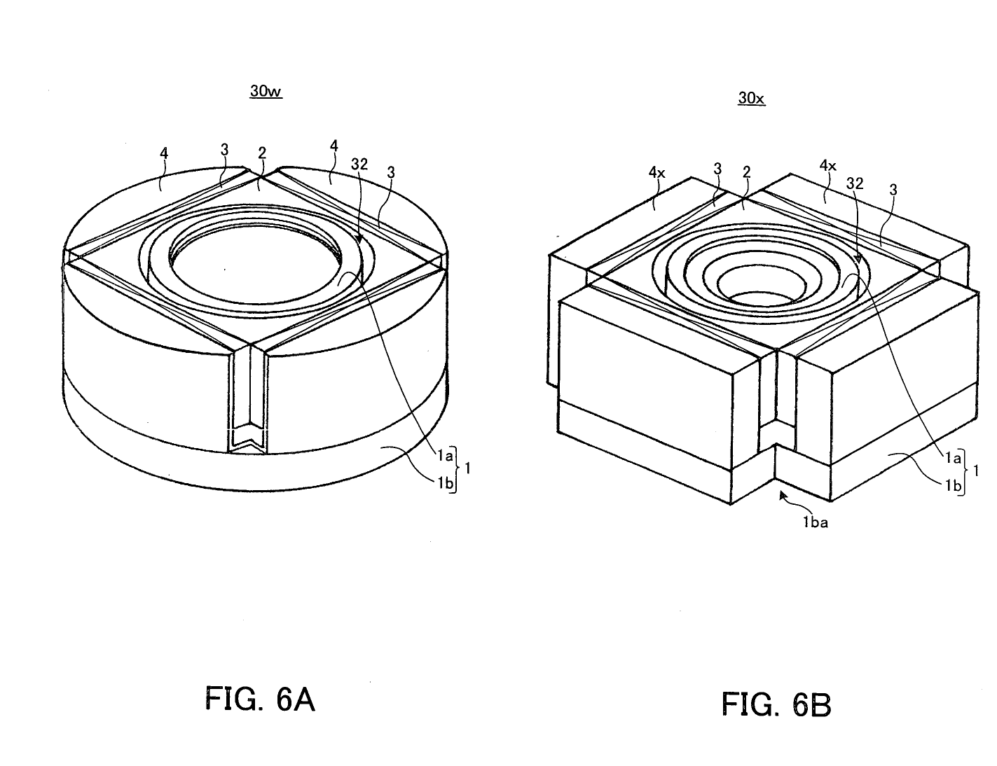

The present invention is characterized in that the flat plate-shaped magnets 3 are applied to the radial-type magnetic circuit 30. Therefore, in the magnetic circuit 30, the shapes and sizes of the components other than the flat plate-shaped magnets 3 are not limited, and the components are variously deformable. Additionally, in the present invention, since it is sufficient that the magnets 3 are formed into the flat plate shape, the cross section of the magnets 3 is not limited. Now, a description will be given of a configuration of a magnetic circuit according to various kinds of modifications, with reference to FIGS. 6A and 6B to FIG. 8. The same reference numerals are given to the same components as those of the above-mentioned embodiment hereinafter, and explanations thereof are omitted.

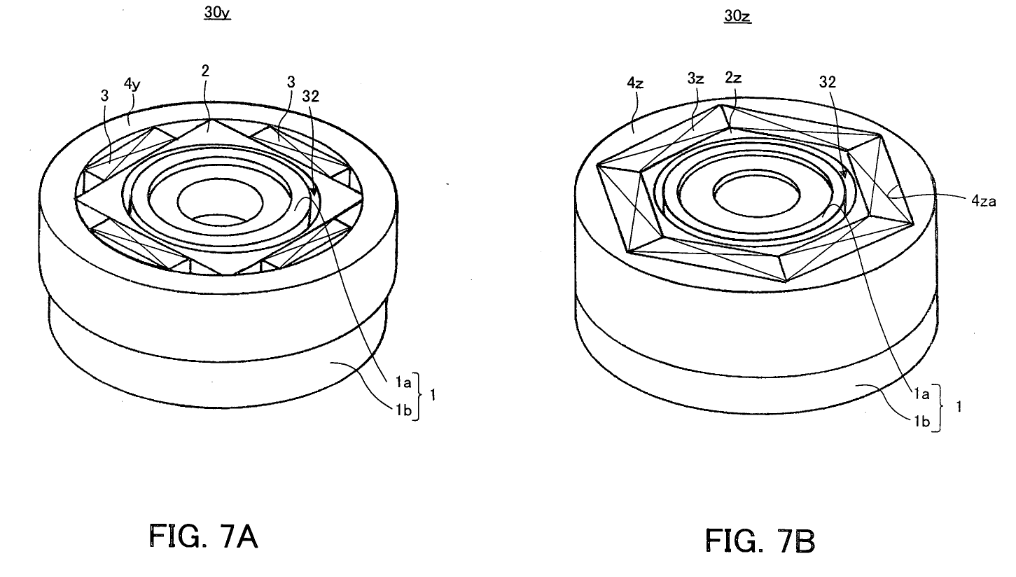

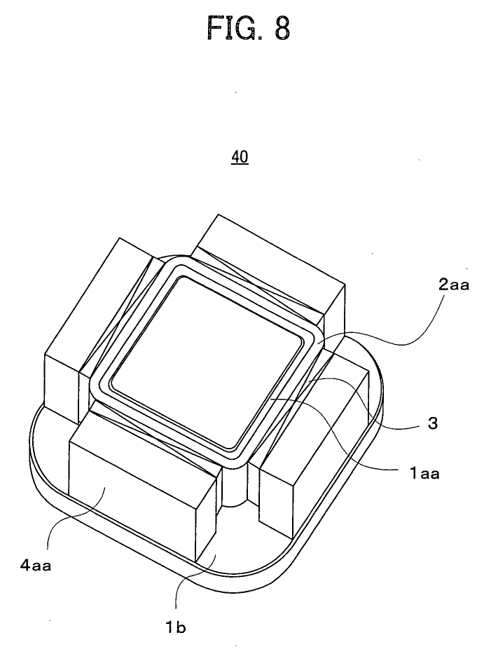

FIG. 6A is a perspective view showing a configuration of a magnetic circuit 30w according to a first modification. FIG. 6B is a perspective view showing a configuration of a magnetic circuit 30x according to a second modification. FIG. 7A is a perspective view showing a configuration of a magnetic circuit 30y according to a third modification. FIG. 7B is a perspective view showing a configuration of a magnetic circuit 30z according to a fourth modification. FIG. 8 is a perspective view of a magnetic circuit 40 of a fifth modification.

When the magnetic circuit 30 of the above embodiment and the magnetic circuit 30w of the first modification are compared, the magnetic circuit 30 and the magnetic circuit 30w are different in that no cut-out part is provided at the flange part 1b corresponding to the boundary part of the neighboring flat plate-shaped magnets 3 in the first modification. But the magnetic circuit 30 and the magnetic circuit 30w are same in the other components. Thus, in the first modification, the magnetic flux slightly decreases at the parts of the magnetic circuit corresponding to the boundary parts of the neighboring flat plate-shaped magnets 3. However, as compared with the above embodiment, the manufacturing cost of the yoke 1 can be low, because of no working of the yoke 1, i.e., because of providing of no cut-out part 1ba at the yoke 1.

When the magnetic circuit 30 according to the above embodiment and the magnetic circuit 30x of the second modification are compared, each of the second plates 4 has the circular arc-shaped (wagon-shaped or half-circular) cross section in the above embodiment, but each of second plates 4x is formed into the flat plate shape in the second modification. Thereby, as compared with the second plates 4 of the above embodiment, the second plates 4x of the second modification can be easily manufactured, and the part cost of the second plates 4x can be low by the amount. Additionally, in the second modification, the shape of the flange part 1b is formed into the angular shape in correspondence with the shape of the second plates 4x formed into the angular shape, and the cut-out part 1ba is provided at the flange part 1b corresponding to each boundary part of the neighboring magnets 3. Thereby, it can be suppressed that the magnetic flux decreases at the part of the magnetic circuit corresponding to each boundary part of the neighboring flat plate-shaped magnets 3.

When the magnetic circuit 30 according to the above embodiment and the magnetic circuit 30y of the third modification are compared, each of the second plates 4 has the circular arc-shaped (semicylindrical, or half-circular) cross section in the above embodiment, but a second plate 4y is formed into an annular shape in the third modification. Thereby, as compared with the second plates 4 of the above embodiment, the second plate 4y of the third modification can be easily manufactured, and the part cost of the second plate 4y can be low by the amount. In the third modification, the magnets 3 are slightly smaller than those of the above embodiment, in correspondence with the shape of the second plate 4y.

When the magnetic circuit 30 of the above embodiment and the magnetic circuit 30z of the fourth modification are compared, each of the flat plate-shaped magnets 3 has the rectangular cross section in the above embodiment, but each of the flat plate-shaped magnets 3z has a trapezoid cross section in the fourth modification. Moreover, the neighboring flat plate-shaped magnets 3z are attached to each other in the fourth modification. By the configuration, the area of the magnets 3z surrounding the center pole 1a increases in the fourth modification, as compared with the above embodiment and the first to third modifications. Therefore, it becomes possible to obtain more magnetic fluxes in the magnetic gap 32. In the fourth modification, a second plate 4z having an opening 4za corresponding to the shape of the flat plate-shaped magnets 3z is arranged on the outer side of each of the magnets 3z.

When the magnetic circuit 30 according to the above embodiment and the magnetic circuit 40 according to the fifth modification are compared, the inner circumference of the first plate 2 and the outer circumference of the center pole 1a of the magnetic circuit 30 are formed into the circular shapes, but an inner circumference of a first plate 2aa and an outer circumference of a center pole 1aa of the magnetic circuit 40 are formed into rectangles. When planarly observed, each of the second plates 4 of the magnetic circuit 30 is formed into the circular arc shape, but each of second plates 4aa of the magnetic circuit 40 is formed into a rectangle. Particularly, a magnet formed by a well-known method, such as a magnet formed by a parallel magnetic field press and a transverse magnetic field press, may be used. In addition, the magnet is applicable not only to the magnetic circuit 40 but also to the magnetic circuit shown in the above embodiment.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2006-203590 filed on Jul. 26, 2006 including the specification, claims, drawings and summary is incorporated herein by reference in its entirety.

What is claimed is:

1. A magnetic circuit for a speaker device comprising:
a yoke which has magnetism and has a center pole formed into a column shape; and
plural flat plate-shaped magnets which are uniformly arranged around the center pole and form a magnetic gap with the center pole,
wherein each of the flat plate-shaped magnets is magnetized in a direction in parallel with a thickness direction and in a direction of the center pole.

2. The magnetic circuit for the speaker device according to claim 1, wherein the thickness direction is substantially orthogonal to a projecting direction of the center pole.

3. The magnetic circuit for the speaker device according to claim 1, wherein the neighboring flat plate-shaped magnets are not attached to each other.

4. The magnetic circuit for the speaker device according to claim 1,
wherein each of the flat plate-shaped magnets has a trapezoid cross section, and
wherein the neighboring flat plate-shaped magnets are attached to each other.

5. The magnetic circuit for the speaker device according to claim 1, wherein a first plate having magnetism is provided between each of the flat plate-shaped magnets and the center pole.

6. The magnetic circuit for the speaker device according to claim 5, wherein a second plate having magnetism is provided on an outer side of each of the flat plate-shaped magnets.

7. The magnetic circuit for the speaker device according to claim 1,
wherein an outer circumference of the center pole is formed into a rectangle, and
wherein a first plate having an inner circumference formed into a rectangle is arranged between each of the flat plate-shaped magnets and the center pole.

8. A speaker device comprising a magnetic circuit for a speaker device including:
a yoke which has magnetism and has a center pole formed into a column shape; and
plural flat plate-shaped magnets which are uniformly arranged around the center pole and form a magnetic gap with the center pole,
wherein each of the flat plate-shaped magnets is magnetized in a direction in parallel with a thickness direction and in a direction of the center pole.
